(19) United States
(12) Patent Application Publication
(10) Pub. No.: US 2016/0155084 A1
(43) Pub. Date: Jun. 2, 2016

(54) CARGO TRACKING DEVICE

(71) Applicant: ORANGE, Paris (FR)

(72) Inventors: Subash Mandanapu, San Bruno, CA (US); Santhana Krishnasamy, San Ramon, CA (US)

(21) Appl. No.: 14/901,343

(22) PCT Filed: Jun. 24, 2014
(86) PCT No.: PCT/IB2014/001440

§ 371 Date: Dec. 28, 2015

Related U.S. Application Data
(60) Provisional application No. 61/839,657, filed on Jun. 26, 2013.

(51) Int. Cl. G06Q 10/08; H04B 5/00

(52) U.S. Cl. CPC G06Q 10/0833; H04B 5/0062

(57) ABSTRACT

A tracking device including an RFID module to receive data using near field communication, a positioning sensor, a wireless connection module, a processor arranged to deactivate the positioning sensor and the wireless connection manager, measure the current time, receive using the RFID module or the wireless connection manager itinerary data for the tracking device. The itinerary data includes one or more checkpoint times when the RFID module is expected to receive a data transmission. The processor is further arranged, when not detecting a data transmission at a checkpoint time of the itinerary data corresponding to the current time, to activate the positioning sensor to collect the location of the tracking device, and activate the wireless connection module to connect.

### FIELD OF THE PRESENT SYSTEM

The present system generally relates to RFID tags, and more specifically to the tracking of object using such tags.

### BACKGROUND OF THE PRESENT SYSTEM

Today the tracking of objects such as cargos or parcels for delivery relies heavily upon simple bar code or passive RFID (Radio-frequency identification) tags.

In the case of a bar code, a user or an automat will point a reader to the bar code. The code will correspond to an ID that the system can associate to the known location of the reader. Similarly, when a passive RFID tag is used, an active Reader Passive Tag (ARPT) system will comprise an active reader, which transmits request signals to a neighboring tag. The passive tag, powered with the request signal, will awaken and reply with an authentication message.

US2010082457 discloses an illustration of a known tracking solution relying upon passive RFID tags.

Such tracking systems nevertheless requires that the tracked objects are presented to a reader at some point. When an object with such a tag escapes any known locations with a reader, it becomes impossible to track. This is for instance the case with luggage that is lost at airports, after for instance being routed to a destination that is not part of its itinerary. Until their tag is presented to a reader, the item is considered as lost.

Hybrid tags comprising both RFID and GPS (Global Positioning System) are available today from Numerex Corp., referred to as a Global Tag. Such a tag comes with a battery and is programmed to activate several times a day to report its location. Nevertheless the recurrent GPS activation is battery consuming, limiting the tag lifetime. They are simply improper to the tracking of objects such as cargos or suitcases over a long period of time.

There is still a need today for tracking system that is capable of monitoring objects even outside their preset itinerary. There is a further need a tag that can still report its location without being demanding on its battery.

### SUMMARY OF THE PRESENT SYSTEM

The present system relates to a tracking device comprising an RFID module to receive data using near field communication, a positioning sensor, a wireless connection module, and a processor arranged to:
deactivate the positioning sensor and the wireless connection manager,
measure the current time,
receive using the RFID module or the wireless connection manager itinerary data for the tracking device, the itinerary data comprising one or more checkpoint times when the RFID module is expected to receive a data transmission,

the processor being further arranged, when not detecting a data transmission at a checkpoint time of the itinerary data corresponding to the current time:
activate the positioning sensor to collect the location of the tracking device,
activate the wireless connection module to connect over a wireless network and report the collected location.

Thanks to the present tracking device, the positioning sensor and the wireless connection module, which are heavy on the tracking device batteries, are only triggered when needed. A long as the tracking device is presented to checkpoints corresponding to the planned itinerary (as known through the checkpoint times), it will receive a data transmission like the reading of the tag, or a command over NFC. Only in the event that no data transmission is received, the processor of the tracking device will trigger the location sensor to capture the location and report over a wireless connection awakening the wireless. Any lost object or good, equipped with such a tracking device in the form of an hybrid tag as described here after will be retrieved through the reporting of its location when a due checkpoint fails to be presented to the tag.

The present system also relates to a method for tracking object using a tracking device, the tracking device comprising:
an RFID module to receive data using near field communication0+,
a positioning sensor,
a wireless connection module,
a processor,
   the method being carried out by the processor and comprising:
deactivating the positioning sensor and the wireless connection manager,
measuring the current time,
receiving using the RFID module or the wireless connection manager itinerary data for the tracking device, the itinerary data comprising one or more checkpoint times when the RFID module is expected to receive a data transmission,
when not detecting a data transmission at a checkpoint time of the itinerary data corresponding to the current time, activating the positioning sensor to collect the location of the tracking device, and
activating the wireless connection module to connect over a wireless network and report the collected location.

The present system also relates to a computer program product stored on a non-transitory computer-readable storage medium, and executable by a computer in the form of a software agent including at least one software module set up to implement a method for tracking object using a tracking device, the tracking device comprising:
an RFID module to receive data using near field communication0+,
a positioning sensor,
a wireless connection module,
a processor,

the computer product comprising instructions for:
deactivating the positioning sensor and the wireless connection manager,
measuring the current time,
receiving using the RFID module or the wireless connection manager itinerary data for the tracking device, the itinerary data comprising one or more checkpoint times when the RFID module is expected to receive a data transmission,
when not detecting a data transmission at a checkpoint time of the itinerary data corresponding to the current time, activating the positioning sensor to collect the location of the tracking device, and
activating the wireless connection module to connect over a wireless network and report the collected location.

### BRIEF DESCRIPTION OF THE DRAWINGS

One or more examples of the present system are explained in further detail, and by way of example, with reference to the accompanying drawings wherein:

FIG. 1 shows a hybrid tag in accordance with an embodiment of the present system;

FIG. 2 shows an exemplary embodiment of the present system;

FIGS. 3A-3B shows an exemplary flowchart of the tracking method according to another embodiment of the present system.

### DETAILED DESCRIPTION OF THE PRESENT SYSTEM

The following are descriptions of illustrative embodiments that when taken in conjunction with the following drawings will demonstrate the above noted features and advantages, as well as further ones.

In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, circuits, tools, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

For purposes of simplifying a description of the present system, the terms “operatively coupled”, “coupled” and formatives thereof as utilized herein refer to a connection between devices and/or portions thereof that enables operation in accordance with the present system. For example, an operative coupling may include one or more of a wired connection and/or a wireless connection between two or more devices that enables a one and/or two-way communication path between the devices and/or portions thereof. For example, an operative coupling may include a wired and/or wireless coupling to enable communication through a transmission between a hybrid tag according to the present system and another electronic device such as tracking server for tracking objects equipped with such hybrid tags. An operative coupling may also relate to an interaction between program portions and thereby may not describe a physical connection so much as an interaction based coupling.

The system, device(s), method, user interface, etc., described herein address problems in prior art systems. In accordance with an embodiment of the present system, a hybrid tag enables the tracking of objects by only triggering its GPS and wireless modules when a given checkpoint is not detected by the RFID module of the tag as supposed to according to the object preset itinerary.

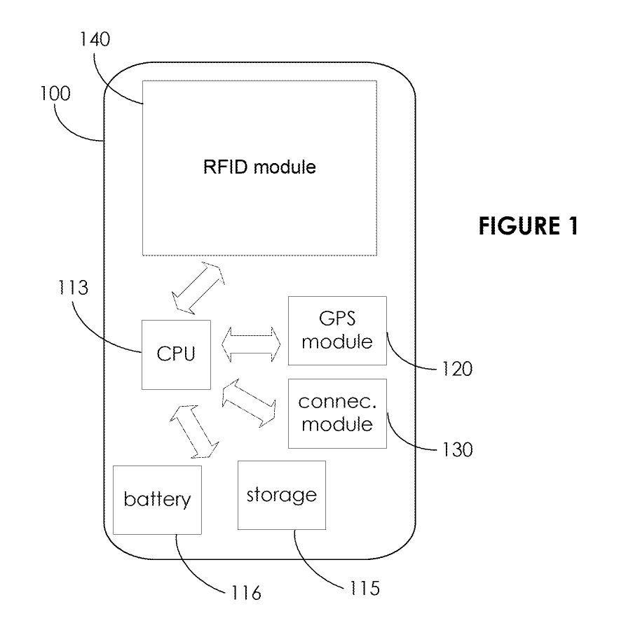

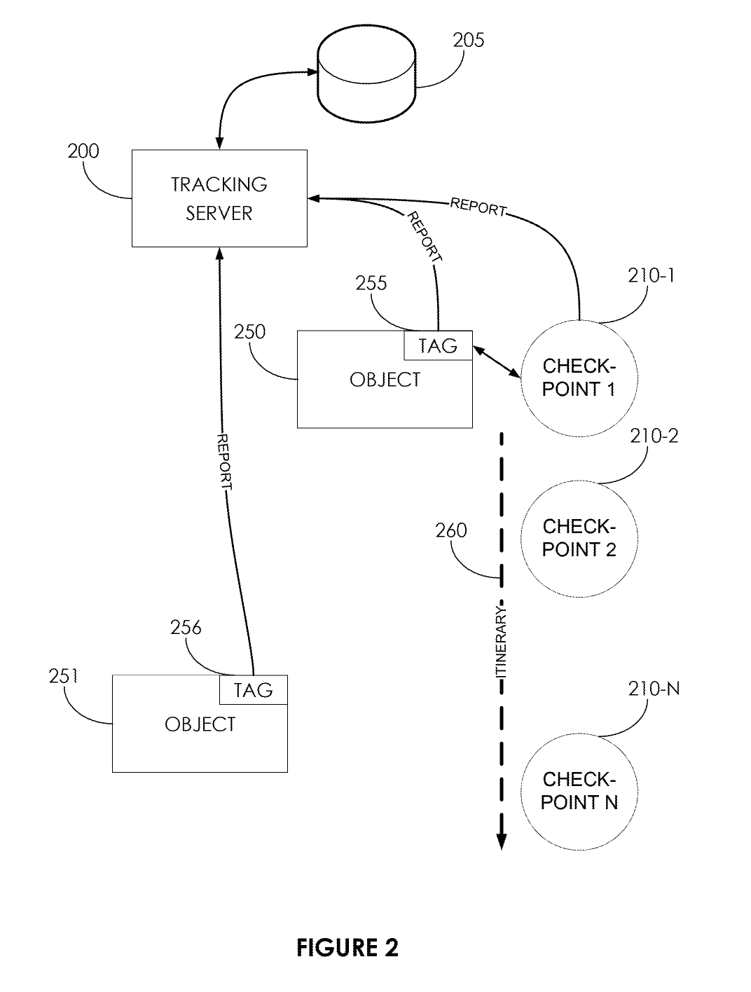

FIG. 2 is an illustration of an exemplary embodiment of the present system. An object 250, like a cargo or a piece of luggage is equipped with a hybrid tag 255 as described herein. The tag may be attached through any association process, like the use of glue, stitching, adhesive, mechanical sealing, temperature based attachment or any of the known attachment process. In the here after description, we will assume that the hybrid tag 255 of the present system remains attached to the object 250 and follows the same itinerary or route. The hybrid tag 250 of the present system will be described later on with regards to FIG. 1. The cargo 250, and consequently the hybrid tag 255 is supposed to follow a route or itinerary 260 comprising a plurality of checkpoints 210, numbered checkpoints 201-1 to 210-N. The checkpoints may be NFC readers exchanging commands and more generally data with the hybrid tag 255 and more specifically its RFID module 140 as seen in FIG. 1.

A tracking server 200 is operatively coupled to the plurality of checkpoints 210 and is aware of the itinerary 260 of the object 250. The itinerary data will comprise data describing the different checkpoints 210 the hybrid tag 255 is supposed to meet, i.e. be presented to, during its itinerary 260. That will comprise e.g. for each NFC reader/checkpoint at least a time (a specific instant or a time interval around that specific instance) when the tag is supposed to receive data through its RFID module. This will be achieved as the tag is presented at the checkpoint to an NFC reader, and received data like checkpoint characteristics such as a checkpoint identifier and/or a checkpoint location. Such times in the itinerary will be referred to hereafter as the checkpoint times.

By being presented to a checkpoint, one may understand that the object 250 and tag 255 are placed to a distance close enough to the reader 210 (the current or present reader/checkpoint hereafter) so that one or more data exchanges may be triggered between the tag and the reader. The exchange may be for instance a request from the checkpoint 210 for an identifier from the tag. The requesting checkpoint 210 will then report the identifier to the tracking server 200. Alternatively, the reporting may go through the hybrid tag 255 using its connection module 130 as described here after to report the identifier, following a request from the current checkpoint.

In the present system each tag is associated through an identifier to an itinerary known by the tracking server 200. The tracking server may be operatively coupled to a database 205 wherein each entry corresponding to a tag identifier is associated to itinerary data. The tag entry may also comprise data like the MSISDN corresponding to the connection module 130 of the tag to either send a message to the tag over a 3G/LTE network or identify a message received from the tag. The tag identifier may be for instance the MSISDN number or a distinct unique number.

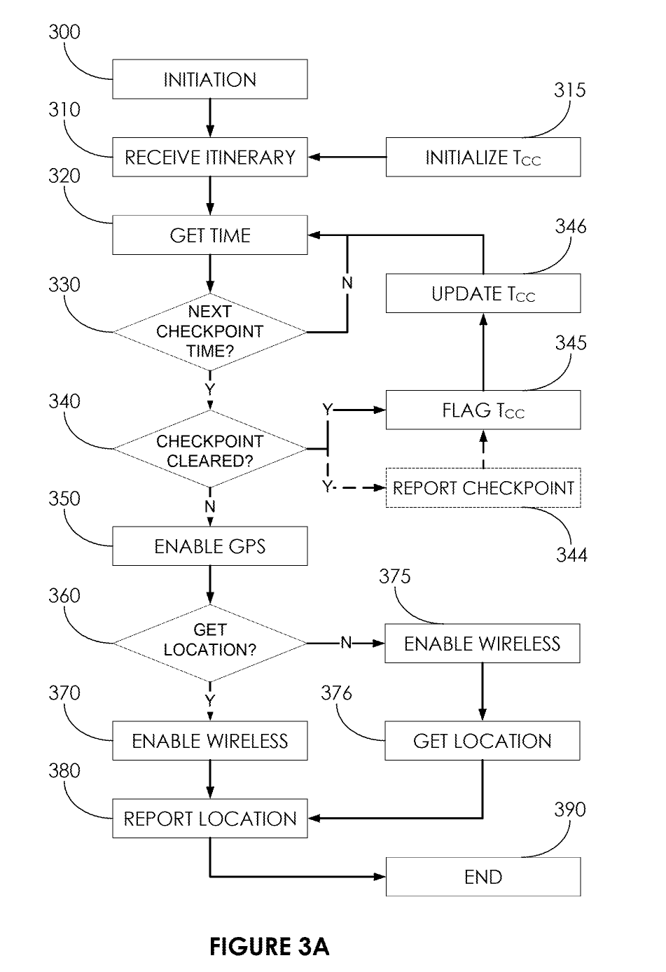

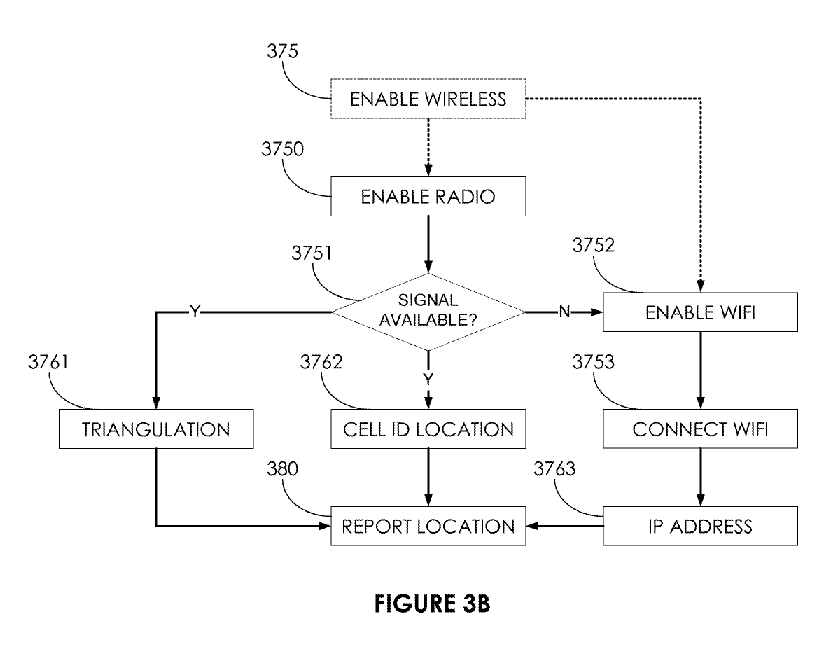

In the present system, such messages may be exchanged when the tag and the object, for some reasons, move away from the intended itinerary as known and stored by the tracking server 210. The present tracking method that allows to retrieve such a lost object 250 will be described here after in association to FIGS. 3.

FIG. 1 is an illustration of an exemplary hybrid tag 100 used in the present tracking system. The present tag is referred to as a hybrid tag as it comprises:
a passive part with an RFID module 140 comprising a RFID antenna like known passive tags. The RFID module is arranged to exchange messages such as commands and more generally data with an NFC (Near Field Communication) reader like checkpoints 210 in FIG. 2,
an active part with a processor 113, a GPS module (or more generally a positioning sensor) 120 to detect the tag location, a connection module or manager 130 to report the location, and a storage 115 (such as a non-transitory computer readable medium) to store a computer program to enable the processor 113 to carry out the present computer implemented method, and store itinerary data for the supposed itinerary of the object 250 carrying such a hybrid tag 100,
a battery 116 to power the processor 113, the storage 115, the GPS module 120 and the connection module 130 when activated.

The GPS module is a known GPS module as existing today in electronic devices such as mobile devices or the known hybrid tags mentioned earlier. Indeed miniaturization enables a tag today to host a GPS module.

The connection module 130 may comprise:
a 3G/LTE module (not shown) to allow the present hybrid tag 100 to connect to a cellular or radio access network like any of the existing 3G/LTE networks. The 3G/LTE module may comprise a SIM (Subscriber Identity Module) card or equivalent for authentication to a cellular network and enable communication over such a network, for instance to a tracking server 200 as see in FIG. 2. The connection module may be identified and reached through its MSISDN number as mentioned before and stored in the tracking server database 205,
an optional wireless module (not shown) to allow the present hybrid tag 100 to detect local wireless networks such as WiFi or WLAN, and connect to one of them for communication over such a wireless network, for instance, to the tracking server 200.

In the present system, as illustrated in FIG. 1, the processor 113 is operatively connected to the RFID module 140, the GPS module 120, the connection module 130 and the storage 115.

The processor 113 of the present hybrid tag 100 is capable of managing an active and passive or sleep mode for the tag:
the active mode is a mode wherein the connection module 130 is powered by the battery 116 and capable of exchanging messages with the tracking server 200 for instance. In the active mode, the GPS module 120 is also powered to tracking the tag's location,
the passive or sleep mode is a mode wherein the GPS module 120 and connection module 130 are deactivated to save the battery's life. In that mode, the processor 113 may be arranged to keep a clock active to measure time and compare the current time as tracked and measured by the processor 113 to the next checkpoint time of the itinerary.

In order to implement the present tracking method and management of the active and sleep modes, the processor will run an application program (application in short) comprising instructions for instance stored in the storage 115 that, when run by the processor 113, will cause the processor to drive the different modules and perform steps comprising:
run a timer or clock to keep track of present time,
receive through the RFID module 140 or the connection module 130 itinerary data for all the checkpoints the hybrid tag is supposed to meet and be presented to,
maintain a sleep mode for the hybrid tag as long as a checkpoint time is not reached. The timer will keep on functioning during the sleep mode so as to keep track of time and compare the current time to the checkpoint times of the itinerary data. Such functioning request today very little resource from the battery 116,
monitor for a command or an identification from a checkpoint reader 210 when the current time reaches a checkpoint time for presentation to a checkpoint. As described here after, the checkpoint time may be defined as precise moment in time, or time intervals around a precise moment so as to allow a margin of error for the presentation to a checkpoint of the tag. The tag may itself define a margin of error applied to all checkpoint times received through the itinerary data, or the itinerary data itself may comprise the interval of time apply before and after the checkpoint time,
maintain the sleep mode when presented to checkpoint reader 210 during that time interval. The tag will respond to the checkpoint reader with its identifier, so that the reader can report it to the tracking server 200. Alternatively, e.g. the reader does not have any connectivity itself, the command received from a checkpoint could include a request to trigger the GPS module 120 and connection module 130 so as to report the current location and checkpoint validation to the tracking server 200 (see optional act 344 in FIG. 3A described here after),
exit the sleep mode when no checkpoint is presented or a wrong checkpoint is presented during the time interval. Entering the active mode will cause the hybrid tag 100 to report its location as described here after in relation to FIGS. 3.

In the present system, the positioning sensor 120 is described as a GPS module. As will be seen from the description here after, the positioning sensor may rely upon triangulation using for instance the base station from the 3G/LTE network it is attached to, or the address of the WiFi/WLAN network it is connected to.

FIG. 3A illustrates an exemplary embodiment of the present method. In an initiation act 300, the tag is applied to the object to be tracked using some kind of adhesive techniques. As mentioned before, the object and the tag are assumed to remain together.

In a further act 310, the hybrid tag 100 receives and stores the itinerary data describing the expected route of the object. The transmission of the itinerary data may be performed using the RFID module 140 of the tag, using an NFC transmission carried out by an NFC reader operatively connected for instance to the tracking server 200 of FIG. 2. As mentioned before, the itinerary data may comprise:
one or more times/instants when the RFID module is expected to receive a data transmission, e.g. from a checkpoint reader, Each of these checkpoint times may be defined as precise instant on a calendar, or a time slot in a specific day of the calendar, so as to allow some uncertainty around the presentation to the checkpoint,
optionally, when the times of the itinerary data are defined as precise instants, an additional time interval to define a time slot around the precise instants,
optionally also characteristics or metadata associated to the reader, like its location and/or an identifier for the reader. The identifier will allow to distinguish the different checkpoints from one another in case the object is presented at the right time but to the wrong checkpoint,
optionally the periodicity P (e.g. measured in seconds) of time measurement for the tag, i.e. how often the tag will get the time and compare it with a checkpoint time of the itinerary data.

To each checkpoint time will correspond a time slot. The duration of this time slot may be more or less large depending on how reliable the displacement of the object may be. A narrow duration will trigger the present method fast after failure to present the tag before the checkpoint reader, while a large duration will allow the triggering as more of a last chance strategy.

The processor will also initialize in a further act 315 the current checkpoint time T_{cc} to the earliest checkpoint time in the itinerary data.

The present tag, and specifically its processor 113 is operable to implement a timer that measures time as mentioned before. In a further act 320, the processor 113 will get the current time T periodically e.g. every P seconds, P being part of the itinerary data or a factory setting. The periodicity ought to be smaller than the duration of the time slots to as to make sure a current time falls within of the time slots of the itinerary data.

In a further act, the processor 113 will compare the current time T to the next expected checkpoint time T_{cc}. As long as the current time does not fall within the time slot associated to the next expected checkpoint time T_{cc} (answer No to act 330), the present method will resume with act 320.

Provided the next expected checkpoint time has been reached (current time T falling within the time slot for T_{cc}, answer Yes to act 330, in other words, the current time matching the current checkpoint time), the processor will then wait for a data transmission through the RFID module 140 in a further act 340. In other words, it will wait at the checkpoint time T_{cc} of the itinerary data corresponding to the current time T a data transmission. To do so, it will expect the data transmission from a checkpoint reader as long as the current time falls with the time slot associated to the current checkpoint time T_{cc}.

Provided it does receive a data transmission over the RFID module 140 (answer Yes to act 340), the processor 113 will flag the current checkpoint time T_{cc} as cleared (act 345). Thus, the processor 113 will stop to monitor the current checkpoint time that corresponds to the current time T. The data transmission may be as simple as a command from the checkpoint reader the tag is presented to. Alternatively it may be characteristics of the checkpoint reader that are then compared to the checkpoint metadata of the itinerary data associated to the current checkpoint time. The processor will then flag the current checkpoint time as cleared only if there is a match. If there is no match, it will consider that there was no presentation to a checkpoint reader, and will carry on expecting the data transmission of act 340 over the time slot for the current checkpoint time.

After the checkpoint time, the processor 113 will then update the current checkpoint to the next earliest checkpoint time in the itinerary data (act 346). The present method will then resume to act 320. During these acts 320, 330, 340 and 345 and 346, the tag was in its sleep mode.

In an optional act 344 after an answer Yes to act 340, that may be carried out at any time between act 340 and the return to act 320, the processor may report to the tracking server that the current checkpoint T_{cc} time has been cleared. To do so, it will trigger the active mode, i.e. trigger the wireless connection module 130, to connect to a network and report to the tracking server the data transmission, i.e. the presentation to the expected checkpoint reader. After reporting the processor 113 will deactivate the connection module 130 and return to the hybrid tag sleep mode.

The data transmission from the checkpoint reader 210 may be a request for the tag identifier. Provided the checkpoint reader has data connection, it may report itself in an alternative embodiment of the present method to the tracking server 200 that the current checkpoint can be cleared.

Provided the current checkpoint time has not been cleared, i.e. no data transmission was detected (answer No to act 350), the processor 113 will end the sleep mode and enter the active mode by triggering first the GPS module 120 in an act 350. In parallel, the tracking server 200, with no reporting that the current checkpoint has been cleared, and may send a first alert message to a person in charge of the lost objects.

Let us assume that the GPS module has a reading (e.g. the object is outdoor), the GPS module will be able to capture the location (answer Yes to act 360). The processor will then activate the connection manager (act 370) to connect over the radio network (using the 3G/LTE module) and report the captured location to the tracking server (act 380). The tracking server 200 will then be able to send a second alert message to report that the lost object is at the reported location.

In an alternative embodiment, when the GPS module 120 cannot capture any location (answer No to act 360), e.g. due to an indoor location for instance, the processor 113 will enable the connection module 130 (act 375) to detect a network and use the detected network to get the tag location (act 376) and report it over a radio network (act 380).

The location detection using solution alternative to the GPS module 120 is described in FIG. 3B. In a further act 3750, the processor 113 will first activate the radio module (3G/LTE). Provided a signal is available (answer Yes to act 3751), the processor may capture the tag location through either triangulation over the different base stations seen by the radio module (act 3761), or using the location of the current cell (act 3762). Alternatively, provided no radio signal is available (answer No to act 3751), the processor will then enable the wireless module (act 3752). It will then connect over an open wireless network (act 3753), get the IP address of the wireless network (act 3763), and report the IP address as the tag location (act 380).

Thanks to the present method, the tag location may be reported as soon as the tracked object failed to be presented at a checkpoint of its itinerary or route.

Finally, the above discussion is intended to be merely illustrative of the present system and should not be construed as limiting the appended claims to any particular embodiment or group of embodiments. Thus, while the present system has been described with reference to exemplary embodiments, such as sound based data transmission, it should also be appreciated that numerous modifications and alternative embodiments may be devised by those having ordinary skill in the art without departing from the broader and intended spirit and scope of the present system as set forth in the claims that follow. For instance, reference was made to a mobile device as an exemplary embodiment of the user equipment. Other user equipment such as pads, tablets, portable computers may benefit from the present teachings.

The section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or an preceding an element does not exclude the presence of a plurality of such elements;

c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise;
h) no specific sequence of acts or steps is intended to be required unless specifically indicated; and
i) the term “plurality of” an element includes two or more of the claimed element, and does not imply any particular range of number of elements; that is, a plurality of elements may be as few as two elements, and may include an immeasurable number of elements.

The system or systems described herein may be implemented on any form of computer or computers and the components may be implemented as dedicated applications or in client-server architectures, including a web-based architecture, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor on a non-transitory computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media is readable by the computer, stored in the memory, and executed by the processor. For example one or more parts of the system may be implemented by a computer processor with associated memory and timing circuitry (not separately shown) that is a functional part of the system and is activated by, and facilitates functionality of other components or parts of the system.

The present disclosure may be described in terms of functional block components and various processing steps. Such functional blocks may be realized by any number of hardware and/or software components that perform the specified functions. For example, embodiments of the present disclosure may employ various integrated circuit components, e.g., memory elements, processing elements, logic elements, look-up tables, and the like, which may carry out a variety of functions under the control of one or more microprocessors or other control devices. Similarly, where the elements of various aspects of the present disclosure are implemented using software programming or software elements the aspects of the present disclosure may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, aspects of the present disclosure could employ any number of conventional techniques for electronics configuration, signal processing and/or control, data processing and the like.

While there has been illustrated and described one or more embodiments of the present disclosure, it will be understood by those skilled in the art that various other modifications may be made, and equivalents may be substituted, without departing from the true scope of the present and/or the appended claims. Additionally, many modifications may be made to adapt a particular situation to the teachings of the present system without departing from the central inventive concept described herein. Furthermore, an embodiment of the present disclosure may not include all of the features described above. Therefore, it is intended that the present disclosure not be limited to the particular embodiments disclosed, but that the disclosure include all embodiments falling within the scope of the disclosure as broadly defined above.

A person skilled in the art will readily appreciate that various parameters disclosed in the description may be modified and that various embodiments disclosed and/or claimed may be combined without departing from the scope of the disclosure.

What is claimed is:

1. A tracking device comprising:
an RFID module to receive data using near field communication,
a positioning sensor,
a wireless connection module,and
a processor arranged to:
deactivate the positioning sensor and the wireless connection manager,
measure the current time, and
receive using the RFID module or the wireless connection manager itinerary data for the tracking device, the itinerary data comprising one or more checkpoint times when the RFID module is expected to receive a data transmission,
the processor being further arranged to, when not detecting a data transmission at a checkpoint time of the itinerary data corresponding to the current time:
activate the positioning sensor to collect the location of the tracking device, and
activate the wireless connection module to connect over a wireless network and report the collected location.

2. The tracking device of claim 1, the processor being further arranged to:
detect a data transmission at a checkpoint time of the itinerary data corresponding to the current time,
stop monitoring the checkpoint time of the itinerary data corresponding to the current time.

3. The tracking device of claim 2, the processor being further arranged to:
activate the wireless connection module to report the detection of the data transmission.

4. The tracking device of claim 2, wherein the itinerary data further comprises metadata associated to each checkpoint time, the stopping being carried out by the processor only when there is a match between the detected data transmission and the metadata of the checkpoint time corresponding to the current time.

5. The tracking device of claim 1, wherein the positioning sensor is a GPS module.

6. The tracking device of claim 1, wherein the positioning sensor is based the wireless module.

7. A method for tracking object using a tracking device, the tracking device comprising:
an RFID module to receive data using near field communication,
a positioning sensor,
a wireless connection module, and
a processor,
the method being carried out by the processor and comprising:
deactivating the positioning sensor and the wireless connection manager,
measuring the current time,
receiving using the RFID module or the wireless connection manager itinerary data for the tracking device, the itinerary data comprising one or more checkpoint times when the RFID module is expected to receive a data transmission,
when not detecting a data transmission at a checkpoint time of the itinerary data corresponding to the current time, activating the positioning sensor to collect the location of the tracking device, and;
activating the wireless connection module to connect over a wireless network and report the collected location.

8. A non-transitory computer-readable storage medium comprising a computer product stored thereon and executable by a computer in the form of a software agent including at least one software module set up to implement a method for tracking object using a tracking device, the tracking device comprising:
an RFID module to receive data using near field communication,
a positioning sensor,
a wireless connection module,
a processor,
the computer product comprising :
instructions that configure the computer to deactivate the positioning sensor and the wireless connection manager,
instructions that configure the computer to measure the current time,
instructions that configure the computer to receive using the RFID module or the wireless connection manager itinerary data for the tracking device, the itinerary data comprising one or more checkpoint times when the RFID module is expected to receive a data transmission,
instructions that configure the computer to, when not detecting a data transmission at a checkpoint time of the itinerary data corresponding to the current time, activate the positioning sensor to collect the location of the tracking device, and
instructions that configure the computer to activate the wireless connection module to connect over a wireless network and report the collected location.
